(19) United States
(12) Patent Application Publication
(10) Pub. No.: US 2023/0292754 A1
(43) Pub. Date: Sep. 21, 2023

(54) Pest Repellents and Uses Thereof

(71) Applicants: Sensorygen, Inc., South Pasadena, CA (US); University of California Riverside, Riverside, CA (US)

(72) Inventors: Anandasankar RAY, Riverside, CA (US); Thomas STONE, South Pasadena, CA (US)

(21) Appl. No.: 17/771,622

(22) PCT Filed: Oct. 18, 2021
(86) PCT No.: PCT/US2021/055427

§ 371 Date: Apr. 25, 2022

Related U.S. Application Data
(60) Provisional application No. 63/092,660, filed on Oct. 16, 2020.

(51) Int. Cl. A01N 37/44; A01N 25/24; A01P 17/00

(52) U.S. Cl. CPC A01N 37/44; A01N 25/24; A01P 17/00

(57) ABSTRACT

The invention provides improved natural insect repellent compositions comprising a repellent, a fixative, a film-forming agent, and an optional solvent. The present invention also includes methods of repelling the insects.

### CROSS-REFERENCE TO A RELATED APPLICATION

This application claims the benefit of U.S. provisional application Serial No. 63/092,660, filed Oct. 16, 2020, which is incorporated herein by reference in its entirety.

### BACKGROUND OF INVENTION

Insects are common vectors for disease, often transferring parasites, viruses, and bacteria from reservoir hosts. Mosquitoes in the genus Anopheles are the principle vectors of malaria, a disease caused by protozoa in the genus Trypanosoma. Aedes aegypti is the main vector of the viruses that cause Yellow fever, Dengue, Zika, and Chikungunya. Other viruses, the causal agents of various types of encephalitis, are also carried by Aedes spp. mosquitoes. Wuchereria bancrofti and Brugia malayi, parasitic roundworms that cause filariasis, are usually spread by mosquitoes in the genera Culex, Mansonia, and Anopheles.

Horse flies and deer flies may transmit the bacterial pathogens of tularemia (Francisella tularensis) and anthrax (Bacillus anthracis), as well as a parasitic roundworm (Loa loa) that causes Loa loa filariasis in tropical Africa.

Eye gnats in the genus Hippelates can carry the spirochete pathogen that causes yaws (Treponema pertenue), and may also spread conjunctivitis (pinkeye). Tsetse flies in the genus Glossina transmit the protozoan pathogens that cause African sleeping sickness (Trypanosoma gambiense and T. rhodesiense). Sand flies in the genus Phlebotomus are vectors of a bacterium (Bartonella bacilliformis) that causes Carrion’s disease (Oroya fever) in South America. In parts of Asia and North Africa, sand flies spread a viral agent that causes sand fly fever (pappataci fever) as well as protozoan pathogens (Leishmania spp.) that cause leishmaniasis.

Most blood feeding insects, including mosquitoes, sandflies, Tsetse flies, use olfactory cues to identify human hosts. This group of hematophagous insects can transmit a wide assortment of deadly human diseases that together cause more suffering and deaths globally than any other disease condition. Diseases transmitted by such insects include malaria, dengue fever, yellow fever, West Nile virus, filariasis, river blindness, epidemic polyarthritis, leishmaniasis, trypanosomiasis, Japanese encephalitis, St. Louis encephalitis amongst others.

Several repellent compounds have been identified to date. These compounds range from naturally occurring extracts to commercially manufactured compounds. The degree of protection, duration of protection, and safety of these odors varies greatly. The gold standard of these compounds is generally considered to be DEET.

DEET (N,N-diethyl-meta-toluamide) has been used for insect repellency for over 50 years. Protection is generally provided by direct application to the skin in concentrations ranging from 3 to 100 percent. While results vary across experiments, DEET has been shown to act as an irritant and in some cases may cause skin reactions. In a recent study DEET has also just recently been shown to inhibit acetylcholinesterase in humans, which is an important neurotransmitter. DEET is also known to dissolve several products including certain plastics, synthetic fabrics, painted or varnished surfaces.

Several other terpenoid compounds with repellent properties including thujone, eucalyptol, and linalool have also been identified. Icaridin, which is also called picaridin, is also used as an insect repellent. Similar to DEET, it acts as a repellent to several different insect species. It has also been found to be as effective as DEET at repelling insects, while being less irritating than DEET; however, icaridin is toxic to salamander larvae.

Traditional vector control methods often involve the heavy use of chemical insecticides that are harmful to the environment and often to human health. Moreover, insects can develop resistance to these chemicals, suggesting that there is a need to identify novel ways of insect control that are effective, cheap, and environmentally friendly. Integrating methods that inhibit vector-human contact, such as vector control and the use of insect repellents, bed nets, or traps, may play a complementary and critical role in controlling the spread of these deadly diseases.

Thus, there is a need for new, improved compositions for natural arthropod repellents that achieve repellent effects while being safe to use and environmentally friendly.

### BRIEF SUMMARY

The subject invention provides arthropod repellent compositions. Specifically, in preferred embodiments, the subject invention provides topical insect repellent compositions. Advantageously, the repellent compositions and methods of the subject invention are environmentally-friendly, non-toxic, and cost-effective.

Specifically described herein are active arthropod repellent compositions and methods of their use. In preferred embodiments, the repellent compositions and methods do not harm insects or other organisms that are beneficial for, for example, agriculture and/or horticulture, including pollinating organisms.

In preferred embodiments, repellent compositions are provided that comprise an arthropod repellent such as, for example, methyl N,N dimethylanthranilate formulated with a film-forming agent, and a fixative. In specific embodiments, the film-forming agent is capryloyl glycerin/sebacic acid copolymer and the fixative is vanillin.

In certain embodiments the composition can further comprise a solvent such as Sesamum indicum (sesame) seed oil and/or ethyl alcohol.

The subject invention can also be used for preventing, reducing and/or eliminating infection and/or spread of insect-borne disease through the control of disease vector pests. Even further, the subject invention can be used for reducing nuisance pests in the home, lawn or garden.

### BRIEF DESCRIPTION OF THE DRAWING

FIG. 1 shows the complete protection time (mean). Complete Protection Time was calculated using the standard metric of First Confirmed Bite (‘FCB’), which is the time between application of the test material until the time the first probing event that was followed by a another within the same of the next exposure period. N=4 trials each.

### DETAILED DESCRIPTION OF THE INVENTION

The subject invention provides arthropod repellent compositions. Specifically, in preferred embodiments, the subject invention provides improved topical insect repellent compositions. Advantageously, the repellent compositions and methods of the subject invention are environmentally-friendly, non-toxic, and cost-effective.

Specifically described herein are insect repellent compositions and methods for controlling insects. In preferred embodiments, the repellent compositions and methods do not harm insects or other organisms that are beneficial for, for example, agriculture and/or horticulture, including pollinating organisms.

The subject invention can also be used for preventing, reducing and/or eliminating infection and/or spread of insect-borne disease through the control of disease vector pests. Even further, the subject invention can be used for reducing nuisance pests in the home, lawn or garden.

In certain embodiments, repellent compositions are provided, comprising an arthropod repellent such as, for example, methyl N,N dimethylanthranilate. The arthropod repellent is preferably formulated with a film-forming agent and a fixative and, optionally, one or more ingredients selected from a vegetable oil, a product derived from a vegetable oil and a solvent.

In certain embodiments the solvent used in the composition is Sesamum indicum (sesame) seed oil and/or ethyl alcohol, the film-forming agent is capryloyl glycerin/sebacic acid copolymer and the fixative is vanillin.

### Selected Definitions

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the term “control” used in reference to the activity produced by the subject compositions extends to the act of killing, disabling, immobilizing, or reducing population numbers of a pest, or otherwise rendering the pest substantially incapable of causing harm.

As used herein, a “fragrance” is a chemical compound that provides the smell of foods, beverages, spices, or other substances. The chemical compound is designed to interact with the olfactory system. The fragrance can be derived from natural sources such as, for example, those derived from plant, animal, or bacterial sources using filtration or enzymatic reactions. Additionally, the fragrance can be derived from synthetic processing of non-eukaryotic or non-bacterial, such as, for example, coal tar and crude oil. The synthetic fragrance often has the exact chemical makeup as the fragrance derived from natural sources, such as, for example ascorbic acid can be purified from oranges or derived from hydrocarbon sources, but the end chemical is C₆H₈O₆ irrespective of the source. Fragrances can also be used as flavoring agents, designed to interact with olfactory and gustatory systems.

Fixatives are substances that amplify the intensity and lasting qualities of the aromatic components of fragrance materials (Seldner, 1982). Fixatives have lower volatility in comparison with the fragrances (Dobbs et al., 2009). They have the ability to slow the evaporation of volatile oils.

As used herein, a “vegetable oil” is oil derived from a plant, combination of plants, seeds of plants, or any other component of plant.

As used herein, the term “arthropod” shall be used in this application; however, it should be understood that the term “arthropod” refers, not only to insects, but also to mites, spiders, ticks, arachnoids, arachnids, larvae, parasites, and like invertebrates.

As used herein, “repellent effect” is an effect wherein more arthropods are deterred away from a host or area that has been treated with the composition than a control host or area that has not been treated with the composition. In some embodiments, repellent effect is an effect wherein at least about 50% of arthropods are repelled away from a host or area that has been treated with the composition. In some embodiments, repellent effect is an effect wherein at least about 75% of arthropods are repelled away from a host or area that has been treated with the composition. In some embodiments, repellent effect is an effect wherein at least about 90% of arthropods are repelled away from a host or area that has been treated with the composition. In some embodiments, repellent effect is an effect wherein at least about 95% of arthropods are repelled away from a host or area that has been treated with the composition. A “repellent” is a chemical composition that provides a repellent effect.

Any compositions or methods provided herein can be combined with one or more of any of the other compositions and methods provided herein.

Other features and advantages of the invention will be apparent from the following description of the preferred embodiments thereof, and from the claims. All references cited herein are hereby incorporated by reference.

### Repellent Compositions According to the Subject Invention

In preferred embodiments, the subject invention provides improved repellent compositions, wherein the composition comprises an arthropod repellent, a film-forming agent, and a fixative. A solvent and/or other ingredients can also be included.

In certain preferred embodiments, the arthropod repellent is methyl N,N dimethylanthranilate. Non-limiting examples of other repellants are listed in Table 1.

TABLE 1

| Chemical Name | CAS# |
|---|---|
| Hydroxycitronellal methyl anthranilate schiff’s base | 89-43-0 |
| beta-napthyl anthranilate | 63449-68-3 |
| linalyl anthranilate | 7149-26-0 |
| Methyl 2-(4-tert-butylphenyl)acetate | 3549-23-3 / 33155-60-1 |
| 2-isothiocyanatoethylbenzene ( Phenethyl Isothiocyanate) | 2257-09-2 |
| Methyl Jasmonate | 39924-52-2 |
| Ethyl anthranilate | 87-25-2 |
| Citrus aurantium flower oil (Neroli extract) | 8016-38-4 |
| Isobutyl Anthranilate | 7779-77-3 |
| Ivy carbaldehyde / methyl anthranilate schiffs base | 68738-99-8 |
| Methyl Anthranilate | 134-20-3 |
| Butyl Anthranilate | 7756-96-9 |
| 4-acetoxy-2,5-dimethyl-3(2h)furanone | 4166-20-5 |
| Isopropyl anthranilate | 18189-02-1 |
| Epsilon-Caprolactam | 105-60-2 |
| 1-(2,6,6-trimethyl-1-cyclohex-2-enyl)hepta-1,6-dien-3-one (Allyl Ionone) | 79-78-7 |
| acetyl methyl anthranilate | 2719-08-6 |
| methyl dihydrojasmonate | 24851-98-7 |
| 4-methyl cyclohexene | 591-47-9 |
| P-tert-butyl-alpha-methylhydrocinnamal / Methyl Anthranilate schiff’s base | 91-51-0 |
| Phenethyl anthranilate | 133-18-6 |
| 2,4-ivy carbaldehyde / methyl anthranilate schiff’s base (triplal) | 68845-02-3 |

The compositions of the subject invention contain the active arthropod repellent at a concentration of about 1% to about 99.9%, about 2% to about 98%, about 3% to about 97%, about 3% to about 96%, or about 3% to about 95%.

The film-forming agent can be, for example, capryloyl glycerin/sebacic acid copolymer. Other non-limiting examples of film-forming agents are listed in Table 2.

TABLE 2

Trimethylsiloxysilicate
Cyclopentasiloxane
Dimethicone
Isododecane
Acrylates/Polytrimethylsi- loxymethacrylate Copolymer and Laureth-1 Phosphate
Acrylates Copolymer
Ethylcellulose
Polyvinylpyrrolidone
vinylpyrrolidone and long-chain a-olefins
vinylpyrrolidone and Eicosene coploymer

Useful film-forming polymers include: capryloyl glycerin/sebacic acid copolymer; copolymers of octadecene and maleic anhydride; copolymers of 1-triacontane and vinyl pyrrolidone; acrylates/octylacrylamide copolymer; acrylates/PVP copolymer; acrylates/acrylamide copolymer; acrylates/VA copolymer; ethylene/maleic anhydride copolymer; polyisobutene; polyvinyl alcohol; PVP/eicosane copolymer; starch/acrylates/acrylamide copolymer; and hexanedioic acid polymers.

Such ingredients can generally be present in the formulation at a concentrations of about 0.1% to about 50%, about 0.5% to about 25%, or about 1% to about 10%.

In preferred embodiments, the fixative used in the compositions of the subject invention is vanillin (4-hydroxy-3-methoxybenzaldehyde). Other fixatives that can be used according to the present invention include, but are not limited to, Glucam P-20, Fixolide, 2,2,4-trimethyl-1,3-pentane diol, Tihetene® (2,6-dinitro-3,4,5-triethyl-t-butyl benzene), Moskene® (4,6-dinitro-1,1,3,3,5-pentamethyl indan), musk ambrette (2,4-dinitro-3-methyl-6-t-butyl anisole), musk xylol (5-t-butyl-2,4,6-trinitro-m-xylene), musk ketone (4-t-butyl-3,5-dinitro-2,6-dimethyl acetophenone), benzylcinnamate, givambrol (2,4-di-t-butyl-5-methoxybenzalde-hyde), isopropyl palmitate, diethyl pthalate, glycerin, benzyl benzoate, PVP, hydroxyethyl cellulose, cinnamic alcohol, benzophenone, musk ketone, Fixative 505, Peru balsam, benzoin resin, tonka bean, sandalwood, amyris oil, copaiba oil, eso e super, castoreum, ambroxide, sucrose acetate isobutyrate, cuvet, galaxolide, ambergris, and clary sage.

In certain embodiments, one or more solvents can be used in the compositions of the subject invention. The solvent can be an oil such as, for example, vegetable oil or derived product including canola oil, peanut oil, olive oil, palm oil, soybean oil, rapeseed oil, cocoa butter, rice bran oil, sunflower oil, coconut oil, corn oil, cottonseed oil, palm oil, safflower oil, Sesamum indicum (sesame) seed oil, or castor bean oil. Solvents can further include water, glycols, and/or alcohols. In certain embodiments, the alcohol can be ethyl alcohol, isopropyl alcohol, 1-propanol, methanol, isobutanol, and/or ethylene glycol. Such ingredients can generally be present in the composition at a concentration of about 10% to about 99.9%, about 20% to about 99.9%, or about 30% to about 99.9%.

Additionally, a vegetable oil-derived product can be used in the compositions of the subject invention. In certain embodiments, the vegetable oil-derived product can be, for example, carboxylic acids, including fatty acids, or combinations of different carboxylic acids thereof. The carboxylic acids can be combined to create copolymers using additives such as, for example, glycerin. Exemplary carboxylic acids include linear saturated dicarboxylic acids, such as, for example, oxalic acid, malonic acid, succinic acid, glutaric acid, adipic acid, pimelic acid, suberic acid, azelaic acid, and sebacic acid. Exemplary fatty acids include saturated fatty acids such as, for example, butryric acid, caproic acid, caprylic acid, capric acid, lauric acid, myristic acid, palmitic acid, stearic acid, arachidic acid, behenic acid, lignoceric acid, cerotic acid, montanic acid, melissic acid, lacceroic acid, geddic acid, hexatriacontylic acid, octatriacontylic acid, or tetracontylic acid; or unsaturated fatty acids, such as for examples, fatty acids with one or more cis or trans configurations. Exemplary unsaturated fatty acids are myristoleic acid, palmitoleic acid, sapienic acid, oleic acid, elaidic acid, vaccenic acid, linoleic acid, linoelaidic acid, arachidonic acid, eicosapentaenoic acid, erucic acid, and docosahexaenoic acid.

The repellent composition is preferably formulated for application to clothing, fur, or skin. In certain embodiments, the composition is formulated as, for example, a liquid, dust, granules, microgranules, pellets, wettable powder, flowable powder, emulsions, microcapsules, oils, lotions, gels, or aerosols.

To improve or stabilize the effects of the composition, it can be blended with suitable adjuvants and then used as such or after dilution if necessary. In preferred embodiments, the composition is formulated as a liquid, which can be mixed with water and other components to form a liquid product.

In one embodiment, the repellent composition can be mixed with an acceptable carrier. The acceptable carrier for purposes of the present invention can be defined as a substance or mixture of substances (e.g., oils, emulsions and suspensions) capable of dispersing the active components without affecting its ability to perform its intended function. The compositions may be in the form of oil, emulsion or suspension type.

Other components are commonly included in topical products. The compositions of the subject invention can also contain stabilizers, vitamins, humectants, skin conditioners, antioxidants, emulsifiers, solubilizers, propellants, emollient, flow-controlling agent, corrosion inhibitors, or dyes.

### Additional Skin Care Agents

The compositions of the present invention may contain one or more skin care agents.

These agents should be suitable for application to epidermal tissue, that is, when incorporated into the composition they are suitable for use in contact with human epidermal tissue without undue toxicity, incompatibility, instability, allergic response, and the like. The CTFA Cosmetic Ingredient Handbook, Second Edition (1992) describes a wide variety of nonlimiting cosmetic and pharmaceutical ingredients commonly used in the skin care industry, which are suitable for use in the compositions of the present invention.

Examples of such ingredient classes include: abrasives, absorbents, aesthetic components such as fragrances, pigments, colorings/colorants, essential oils, skin sensates, astringents, etc. (e.g., clove oil, menthol, camphor, eucalyptus oil, eugenol, menthyl lactate, witch hazel distillate), anti-acne agents, anti-caking agents, antifoaming agents, antimicrobial agents (e.g., iodopropyl butylcarbamate), antioxidants, binders, biological additives, buffering agents, bulking agents, chelating agents, chemical additives, colorants, cosmetic astringents, cosmetic biocides, denaturants, drug astringents, external analgesics, film formers or materials, e.g., polymers, for aiding the film-forming properties and substantivity of the composition (e.g., copolymer of eicosene and vinyl pyrrolidone), opacifying agents, pH adjusters, propellants, reducing agents, sequestrants, skin bleaching and lightening agents (e.g., hydroquinone, kojic acid, ascorbic acid, magnesium ascorbyl phosphate, ascorbyl glucosamine), skin-conditioning agents (e.g., humectants, including miscellaneous and occlusive), skin soothing and/or healing agents (e.g., panthenol and derivatives (e.g., ethyl panthenol), aloe vera, pantothenic acid and its derivatives, allantoin, bisabolol, and dipotassium glycyrrhizinate), skin treating agents, thickeners, and vitamins and derivatives thereof.

In any embodiment of the present invention, however, the agents useful herein can be categorized by the benefit they provide or by their postulated mode of action. However, it is to be understood that the additional agents for use herein can in some instances provide more than one benefit or operate via more than one mode of action. Therefore, classifications herein are made for the sake of convenience and are not intended to limit the agent to that particular application or applications listed.

### Desquamation Agents

A safe and effective amount of a desquamation agent may be added to the compositions of the present invention, more preferably from about 0.1% to about 10%, even more preferably from about 0.2% to about 5%, also preferably from about 0.5% to about 4%, by weight of the composition. The desquamation agents tend to improve the texture of the skin (e.g., smoothness). One desquamation system that is suitable for use herein contains sulfhydryl compounds and zwitterionic surfactants and is described in U.S. Pat. No. 5,681,852, to Bissett, incorporated herein by reference. Another desquamation system that is suitable for use herein contains salicylic acid and zwitterionic surfactants and is described in U.S. Pat. No. 5,652,228 to Bissett, incorporated herein by reference. Zwitterionic surfactants such as described in these applications are also useful as desquamatory agents herein, with cetyl betaine being particularly preferred.

### Anti-Acne Agents

The compositions of the present invention may contain a safe and effective amount of one or more anti-acne agents. Examples of useful anti-acne agents include resorcinol, sulfur, salicylic acid, benzoyl peroxide, erythromycin, zinc, etc. Further examples of suitable anti-acne agents are described in further detail in U.S. Pat. No. 5,607,980, issued to McAtee et al, on Mar. 4, 1997.

### Anti-Wrinkle Agents/Anti-Atrophy Agents

The compositions of the present invention may further contain a safe and effective amount of one or more anti-wrinkle agents or anti-atrophy agents. Exemplary anti-wrinkle/anti-atrophy agents suitable for use in the compositions of the present invention include sulfur-containing D and L amino acids and their derivatives and salts, particularly the N-acetyl derivatives, a preferred example of which is N-acetyl-L-cysteine; thiols, e.g. ethane thiol; hydroxy acids (e.g., alpha-hydroxy acids such as lactic acid and glycolic acid or beta-hydroxy acids such as salicylic acid and salicylic acid derivatives such as the octanoyl derivative), phytic acid, lipoic acid; lysophosphatidic acid, skin peel agents (e.g., phenol and the like), vitamin B₃ compounds, retinoids, and hyaluronic acid, which enhance the epidermal tissue appearance benefits of the present invention, especially in regulating epidermal tissue condition, e.g., skin condition.

### Vitamin B₃ Compounds

The compositions of the present invention may contain a safe and effective amount of a vitamin B₃ compound. Examples of suitable vitamin B₃ compounds are well known in the art and are commercially available from a number of sources, e.g., the Sigma Chemical Company (St. Louis, Mo.); ICN Biomedicals, Inc. (Irvin, Calif.) and Aldrich Chemical Company (Milwaukee, Wis.). The vitamin compounds may be included as the substantially pure material, or as an extract obtained by suitable physical and/or chemical isolation from natural (e.g., plant) sources.

### Retinoids

The compositions of the present invention may also contain a retinoid. As used herein, “retinoid” includes all natural and/or synthetic analogs of Vitamin A or retinol-like compounds which possess the biological activity of Vitamin A in the skin as well as the geometric isomers and stereoisomers of these compounds. The retinoid is preferably retinol, retinol esters (e.g., C₂ -C₂₂ alkyl esters of retinol, including retinyl palmitate, retinyl acetate, retinyl propionate), retinal, and/or retinoic acid (including all-trans retinoic acid and/or 13-cis-retinoic acid), more preferably retinoids other than retinoic acid. These compounds are well known in the art and are commercially available from a number of sources, e.g., Sigma Chemical Company (St. Louis, Mo.), and Boerhinger Mannheim (Indianapolis, Ind.). Preferred retinoids are retinol, retinyl palmitate, retinyl acetate, retinyl propionate, retinal and combinations thereof.

### Hydroxy Acids

The compositions of the present invention may contain a safe and effective amount of a hydroxy acid. Preferred hydroxy acids for use in the compositions of the present invention include salicylic acid and salicylic acid derivatives.

### Anti-Oxidants/Radical Scavengers

The compositions of the present invention may include a safe and effective amount of an antioxidant/radical scavenger. The anti-oxidant/radical scavenger is especially useful for providing protection against UV radiation which can cause increased scaling or texture changes in the stratum corneum and against other environmental agents which can cause skin damage.

A safe and effective amount of an anti-oxidant/radical scavenger may be added to the compositions of the subject invention, preferably from about 0.1% to about 10%, more preferably from about 1% to about 5%, of the composition.

Anti-oxidants/radical scavengers such as ascorbic acid (vitamin C) and its salts, ascorbyl esters of fatty acids, ascorbic acid derivatives (e.g., magnesium ascorbyl phosphate, sodium ascorbyl phosphate, ascorbyl sorbate), tocopherol (vitamin E), tocopherol sorbate, tocopherol acetate, other esters of tocopherol, butylated hydroxy benzoic acids and their salts, 6-hydroxy-2,5,7,8-tetramethylchroman-2-carboxylic acid (commercially available under the tradename Trolox®), gallic acid and its alkyl esters, especially propyl gallate, uric acid and its salts and alkyl esters, sorbic acid and its salts, lipoic acid, amines (e.g., N,N-diethylhydroxylamine, amino-guanidine), sulfhydryl compounds (e.g., glutathione), dihydroxy fumaric acid and its salts, lycine pidolate, arginine pilolate, nordihydroguaiaretic acid, bioflavonoids, curcumin, lysine, methionine, proline, superoxide dismutase, silymarin, tea extracts, grape skin/seed extracts, melanin, and rosemary extracts may be used. Preferred anti-oxidants/radical scavengers are selected from tocopherol sorbate and other esters of tocopherol, more preferably tocopherol sorbate. For example, the use of tocopherol sorbate in topical compositions and applicable to the present invention is described in U.S. Pat. No. 4,847,071.

### Chelators

The compositions of the present invention may also contain a safe and effective amount of a chelator or chelating agent. As used herein, “chelator” or “chelating agent” means an active agent capable of removing a metal ion from a system by forming a complex so that the metal ion cannot readily participate in or catalyze chemical reactions. The inclusion of a chelating agent is especially useful for providing protection against UV radiation which can contribute to excessive scaling or skin texture changes and against other environmental agents which can cause skin damage.

A safe and effective amount of a chelating agent may be added to the compositions of the subject invention, preferably from about 0.1% to about 10%, more preferably from about 1% to about 5%, of the composition. Exemplary chelators that are useful herein are disclosed in U.S. Pat. No. 5,487,884, issued Jan. 30, 1996 to Bissett et al.; International Publication No. 91/16035, Bush et al., published Oct. 31, 1995; and International Publication No. 91/16034, Bush et al., published Oct. 31, 1995. Preferred chelators useful in compositions of the subject invention are furildioxime, furilmonoxime, and derivatives thereof.

### Flavonoids

The compositions of the present invention may optionally contain a flavonoid compound. Flavonoids are broadly disclosed in U.S. Pat. Nos. 5,686,082 and 5,686,367.

Examples of suitable flavonoids include, but are not limited to, unsubstituted flavanone, mono-hydroxy flavanones (e.g., 2′-hydroxy flavanone, 6-hydroxy flavanone, 7-hydroxy flavanone, etc.), mono-alkoxy flavanones (e.g., 5-methoxy flavanone, 6-methoxy flavanone, 7-methoxy flavanone, 4′-methoxy flavanone, etc.), unsubstituted chalcone (especially unsubstituted trans-chalcone), mono-hydroxy chalcones (e.g., 2′-hydroxy chalcone, 4′-hydroxy chalcone, etc.), dihydroxy chalcones (e.g., 2′,4-dihydroxy chalcone, 2’,4′-dihydroxy chalcone, 2,2′-dihydroxy chalcone, 2′,3-dihydroxy chalcone, 2’,5′-dihydroxy chalcone, etc.), and tri-hydroxy chalcones (e.g., 2’,3’,4′-trihydroxy chalcone, 4,2’,4′-trihydroxy chalcone, 2,2’,4′-trihydroxy chalcone, etc.), unsubstituted flavone, 7,2′-dihydroxy flavone, 3’,4′-dihydroxy naphthoflavone, 4′-hydroxy flavone, 5,6-benzoflavone, and 7,8-benzoflavone, unsubstituted isoflavone, daidzein (7,4′-dihydroxy isoflavone), 5,7-dihydroxy-4′-methoxy isoflavone, soy isoflavones (a mixture extracted from soy), unsubstituted coumarin, 4-hydroxy coumarin, 7-hydroxy coumarin, 6-hydroxy-4-methyl coumarin, unsubstituted chromone, 3-formyl chromone, 3-formyl-6-isopropyl chromone, unsubstituted dicoumarol, unsubstituted chromanone, unsubstituted chromanol, and mixtures thereof.

### Anti-Inflammatory Agents

A safe and effective amount of an anti-inflammatory agent may be added to the compositions of the present invention, preferably from about 0.1% to about 10%, more preferably from about 0.5% to about 5%, of the composition. The anti-inflammatory agent enhances the skin appearance benefits of the present invention, e.g., such agents contribute to a more uniform and acceptable skin tone or color. The exact amount of anti-inflammatory agent to be used in the compositions will depend on the particular anti-inflammatory agent utilized since such agents vary widely in potency.

Steroidal anti-inflammatory agents, including but not limited to, corticosteroids such as hydrocortisone, hydroxyltriamcinolone, alpha-methyl dexamethasone, dexamethasone-phosphate, beclomethasone dipropionates, clobetasol valerate, desonide, desoxymethasone, desoxycorticosterone acetate, dexamethasone, dichlorisone, diflorasone diacetate, diflucortolone valerate, fluadrenolone, fluclorolone acetonide, fludrocortisone, flumethasone pivalate, fluosinolone acetonide, fluocinonide, flucortine butylesters, fluocortolone, fluprednidene (fluprednylidene) acetate, flurandrenolone, halcinonide, hydrocortisone acetate, hydrocortisone butyrate, methylprednisolone, triamcinolone acetonide, cortisone, cortodoxone, flucetonide, fludrocortisone, difluorosone diacetate, fluradrenolone, fludrocortisone, diflurosone diacetate, fluradrenolone acetonide, medrysone, amcinafel, amcinafide, betamethasone and the balance of its esters, chloroprednisone, chlorprednisone acetate, clocortelone, clescinolone, dichlorisone, diflurprednate, flucloronide, flunisolide, fluoromethalone, fluperolone, fluprednisolone, hydrocortisone valerate, hydrocortisone cyclopentylpropionate, hydrocortamate, meprednisone, paramethasone, prednisolone, prednisone, beclomethasone dipropionate, triamcinolone, and mixtures thereof may be used. The preferred steroidal anti-inflammatory for use is hydrocortisone.

A second class of anti-inflammatory agents which is useful in the compositions includes the nonsteroidal anti-inflammatory agents. The variety of compounds encompassed by this group are well-known to those skilled in the art. For detailed disclosure of the chemical structure, synthesis, side effects, etc. of non-steroidal anti-inflammatory agents, one may refer to standard texts, including Anti-inflammatory and Anti-Rheumatic Drugs, K. D. Rainsford, Vol. I-III, CRC Press, Boca Raton, (1985), and Anti-inflammatory Agents, Chemistry and Pharmacology, 1, R. A. Scherrer, et al., Academic Press, New York (1974).

### Topical Anesthetics

The compositions of the present invention may also contain a safe and effective amount of a topical anesthetic. Examples of topical anesthetic drugs include benzocaine, lidocaine, bupivacaine, chlorprocaine, dibucaine, etidocaine, mepivacaine, tetracaine, dyclonine, hexylcaine, procaine, cocaine, ketamine, pramoxine, phenol, and pharmaceutically acceptable salts thereof.

### Tanning Agents

The compositions of the present invention may contain a tanning agent. When present, it is preferable that the compositions contain from about 0.1% to about 20%, more preferably from about 2% to about 7%, and still more preferably from about 3% to about 6%, by weight of the composition, of dihydroxyacetone as an artificial tanning agent.

### Skin Lightening Agents

The compositions of the present invention may contain a skin lightening agent. When used, the compositions preferably contain from about 0.1% to about 10%, more preferably from about 0.2% to about 5%, also preferably from about 0.5% to about 2%, by weight of the composition, of a skin lightening agent. Suitable skin lightening agents include those known in the art, including kojic acid, arbutin, ascorbic acid and derivatives thereof (e.g., magnesium ascorbyl phosphate or sodium ascorbyl phosphate), and extracts (e.g., mulberry extract, placental extract). Skin lightening agents suitable for use herein also include those described in the PCT publication No. 95/34280, in the name of Hillebrand, corresponding to PCT Application No. U.S. 95/07432, filed Jun. 12, 1995; and copending U.S. application Ser. No. 08/390,152 filed in the names of Kvalnes, Mitchell A. DeLong, Barton J. Bradbury, Curtis B. Motley, and John D. Carter, corresponding to PCT Publication No. 95/23780, published Sep. 8, 1995.

### Skin Soothing and Skin Healing Agents

The compositions of the present invention may comprise a skin soothing or skin healing agent. Skin soothing or skin healing agents suitable for use herein include panthenoic acid derivatives (including panthenol, dexpanthenol, ethyl panthenol), aloe vera, allantoin, bisabolol, and dipotassium glycyrrhizinate. A safe and effective amount of a skin soothing or skin healing agent may be added to the present composition, preferably, from about 0.1% to about 30%, more preferably from about 0.5% to about 20%, still more preferably from about 0.5% to about 10%, by weight of the composition formed.

### Antimicrobial and Antifungal Agents

The compositions of the present invention may contain an antimicrobial or antifungal agent. Such agents are capable of destroying microbes, preventing the development of microbes or preventing the pathogenic action of microbes. A safe and effective amount of an antimicrobial or antifungal agent may be added to the present compositions, preferably, from about 0.001% to about 10%, more preferably from about 0.01% to about 5%, and still more preferably from about 0.05% to about 2%.

Additionally antimicrobial peptides can be used.

### Sunscreen Agents

Exposure to ultraviolet light can result in excessive scaling and texture changes of the stratum corneum. Therefore, the compositions of the subject invention may optionally contain a sunscreen agent. As used herein, “sunscreen agent” includes both sunscreen agents and physical sunblocks. Suitable sunscreen agents may be organic or inorganic.

### Conditioning Agents

The compositions of the present invention may contain a conditioning agent selected from humectants, moisturizers, or skin conditioners. A variety of these materials can be employed and each can be present at a level of from about 0.01% to about 20%, more preferably from about 0.1% to about 10%, and still more preferably from about 0.5% to about 7% by weight of the composition. These materials include, but are not limited to, guanidine; urea; glycolic acid and glycolate salts (e.g. ammonium and quaternary alkyl ammonium); salicylic acid; lactic acid and lactate salts (e.g., ammonium and quaternary alkyl ammonium); aloe vera in any of its variety of forms (e.g., aloe vera gel); polyhydroxy alcohols such as sorbitol, mannitol, xylitol, erythritol, glycerol, hexanetriol, butanetriol, propylene glycol, butylene glycol, hexylene glycol and the like; polyethylene glycols; sugars (e.g., melibiose) and starches; sugar and starch derivatives (e.g., alkoxylated glucose, fucose, glucosamine); hyaluronic acid; lactamide monoethanolamine; acetamide monoethanolamine; panthenol; allantoin; and mixtures thereof. Also useful herein are the propoxylated glycerols described in U.S. Pat. No. 4,976,953, to Orr et al, issued Dec. 11, 1990.

### Structuring Agents

The compositions hereof, and especially the emulsions hereof, may contain a structuring agent. Structuring agents are particularly preferred in the oil-in-water emulsions of the present invention. Without being limited by theory, it is believed that the structuring agent assists in providing rheological characteristics to the composition which contribute to the stability of the composition. For example, the structuring agent tends to assist in the formation of the liquid crystalline gel network structures. The structuring agent may also function as an emulsifier or surfactant. Preferred compositions of this invention contain from about 0.1% to about 20%, more preferably from about 0.1% to about 10%, still more preferably from about 0.5% to about 9%, of one or more structuring agents.

### Thickening Agent (Including Thickeners and Gelling Agents)

The compositions of the present invention can contain one or more thickening agents, preferably from about 0.1% to about 5%, more preferably from about 0.1% to about 4%, and still more preferably from about 0.25% to about 3%, by weight of the composition.

### Composition Preparation

The compositions useful for the methods of the present invention are generally prepared by conventional methods such as are known in the art of making topical compositions. Such methods typically involve mixing of the ingredients in one or more steps to a relatively uniform state, with or without heating, cooling, application of vacuum, and the like.

### Preservatives

Preservatives can be incorporated into the compositions of the present invention to protect against the growth of potentially harmful microorganisms. While it is in the aqueous phase that microorganisms tend to grow, microorganisms can also reside in the anhydrous or oil phase. As such, preservatives, which have solubility in both water and oil, are preferably employed in the present compositions. Suitable traditional preservatives for compositions of this invention are alkyl esters of parahydroxybenzoic acid. Other preservatives, which can be used include hydantoin derivatives, propionate salts, and a variety of quaternary ammonium compounds.

Particularly preferred preservatives are methylparaben, imidazolidinyl urea, sodium dehydroacetate, propylparaben, trisodium ethylenediamine tetraacetate (EDTA), and benzyl alcohol. The preservative can be selected to avoid possible incompatibilities between the preservative and other ingredients. Preservatives are preferably employed in amounts ranging from about 0.01% to about 2% by weight of the composition. Other preservatives known in the art can be used in the present invention.

### Methods of the Subject Invention to Repel Pests

In one embodiment, the subject invention provides methods for repelling a pest wherein a repellent composition, according to the subject invention, is contacted with the pest or is in close proximity to the pest. The pest can be within, for example, 1 µm, 1 mm, 1 cm, 1 m, 10 m, 100 m or greater of the repellent composition.

In preferred embodiments, the pest is an arthropod, e.g., an insect pest. The pest can be selected from, for example, mosquitos, flies, beetles, cockroaches, ants, larvae, lice, moths, ticks, fleas, chiggers, leaches, and others that may suck blood, bite or sting. Exemplary arthropod orders can include but are not limited to orders Acari, Anoplura, Araneae, Blattodea, Coleoptera, Collembola, Diptera, Grylloptera, Hemiptera, Heteroptera, Homoptera, Hymenoptera, Isopoda, Isoptera, Lepidoptera, Mantodea, Mallophaga, Neuroptera, Odonata, Orthoptera, Psocoptera, Siphonaptera, Symphyla, Thysanura, and Thysanoptera. In certain embodiments, the mosquitoes are in the families Anophelinae or Culicinae. In preferred embodiments, the mosquito is in the genera Aedes, Culex, Coquillettidia or Anopheles. In one embodiment, the pest is a disease vector.

In preferred embodiments, the method comprises contacting a repellent composition comprising an arthropod repellent and any mixtures of any one or more of a solvent, film-forming agent, and/or fixative with the pest. Preferably, the composition comprises an arthropod repellent such as, for example, methyl N,N dimethylanthranilate formulated with a film-forming agent, and a fixative. In specific embodiments, the film-forming agent is capryloyl glycerin/sebacic acid copolymer and the fixative is vanillin.

In certain embodiments the composition can further comprise a solvent such as Sesamum indicum (sesame) seed oil and/or ethyl alcohol

In one embodiment, the method comprises contacting the composition with clothing, fur skin, or other surface upon which the pest may traverse, rest, settle, mate, lay eggs and/or feed. In another embodiment, the method comprises applying the composition directly to the pest. In certain embodiments, “applying” and/or “contacting” a surface and/or pest comprises dropping, rubbing, spraying or sprinkling the composition onto the surface, pest, and/or the environment surrounding the surface and/or pest.

In one embodiment, the method can be used for inhibiting, preventing or reducing the spread and/or incidence of pest-borne disease, for example, in plants, humans and animals, by, for example, controlling a disease vector pest.

In one embodiment, the method can be used to control pests that are considered nuisances in the home, garden and/or lawn. For example, the repellant composition can be applied using, for example, a handheld sprayer, to the lawn, garden, and landscaping surrounding a home to, for example, reduce the populations of a pest that might infest such areas and/or that might enter the home undesirably.

A greater understanding of the present invention and of its many advantages may be had from the following example, given by way of illustration. The following example is illustrative of some of the methods, applications, embodiments and variants of the present invention. This is not to be considered as limiting the invention.

### Example 1 - Comparison of the Repellency Outcomes Using Treated-Collagen Membranes

To quantify the repellent efficacy duration of the test formulation as a percentage of repellency of marketed formulations of DEET, test materials were applied to collagen membranes, which were then secured over petri dishes holding approximately 20 ml warmed defibrinated bovine blood. Test materials were applied to the testing substrate at the industry-standard dosing rate of 1.67 microliters/cm². All test materials were spread evenly on collagen membrane substrate with a surface area of approximately 55 cm².

The formulations tested were: Formulation A4 containing methyl N,N dimethylanthranilate (30%), vanillin (1%), sesame oil (67%), and a capryloyl glycerin/sebacic acid copolymer (LexFilm™ Sun Natural, Inolex, Philadelphia, PA) (2%); and the positive control containing Repel® 15% DEET topical repellent. The negative control was an untreated collagen membrane secured over heated bovine blood.

Repellency of the treatment was tested by 10 avidly probing Aedes aegypti mosquitoes approximately every 30 minutes until repellent failure. Approximately 10 unfed female Aedes aegypti mosquitoes were aspirated into a screen cage and allowed to acclimate. Each exposure period was three minutes in duration, in which the maximum number of probing mosquitoes was recorded. Individual cages of mosquitoes were qualified with an untreated control at the start of testing (all 10 mosquitoes active and probing) and approximately hourly during the course of each test. When not in use, treatments were stored and warmed. Temperature and relative humidity were recorded within the testing room. Temperature ranged from 24-25° C., and relative humidity ranged from 42-68%. These environmental conditions were suitable for data generation throughout the study.

Complete Protection Time was calculated using the standard metric of First Confirmed Bite (‘FCB’), being the time between application of the test material until the time the first probing event that was followed by a another within the same of the next exposure period.

Control mosquito avidity was sufficient throughout the study. In a total of 47 control exposures of mosquitoes, the average proportion of mosquitoes probing in a given simultaneous control was 7.96 (SD 1.25). All control counts met the threshold for avidity (6 of 10), and conditions were judged suitable for challenging repellents throughout the study.

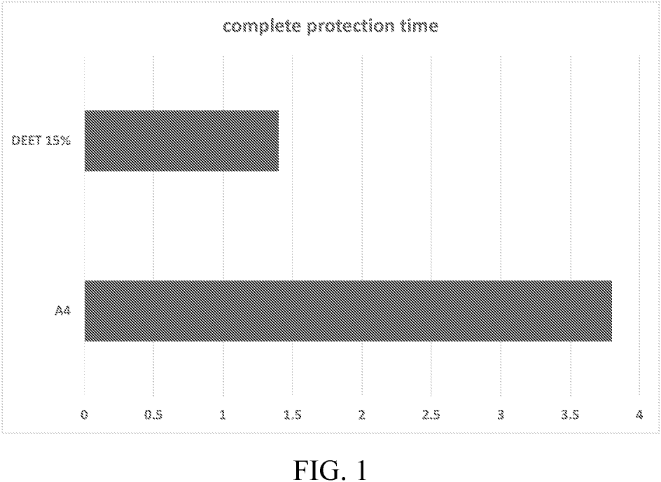

Treated membranes were variously protected by the various repellents tested. A4 outperformed DEET with this assay type (FIG. 1).

We claim:

1. An arthropod repellent composition comprising an arthropod repelling effective amount of an arthropod repellent, a film-forming agent, and a fixative.

2. The composition of claim 1, further comprising a solvent selected from Sesamum indicum seed oil, ethyl alcohol, and/or isopropyl alcohol.

3. The composition of claim 1, wherein the fixative is vanillin.

4. The composition of claim 1, wherein the arthropod repellent is selected from the repellents listed in Table 1.

5. The composition of claim 1, wherein the arthropod repellent is methyl N,N-dimethylanthranilate.

6. The composition of claim 1, wherein the film-forming agent is capryloyl glycerin/sebacic acid copolymer.

7. The composition of claim 1, wherein the arthropod repellent is present in the composition at a concentration of about 3% to about 95%.

8. The composition of claim 1, wherein the fixative is present in the composition at a concentration of about 0.1% to about 5%.

9. The composition of claim 1, wherein the film-forming agent is present in the composition at a concentration of about 1% to about 10%.

10. The composition of claim 2, wherein the solvent is present in the composition at a concentration of about 30% to about 95%.

11. A composition for topical application comprising the repellant composition of claim 1 and a carrier suitable for topical application.

12. The composition for topical application of claim 11, wherein the topical composition is a cream, foam, gel, lotion, ointment, paste, powder, solid, sponge, tape tincture, solution, transdermal patch, vapor, spray, or a skin hygiene/cosmetic product.

13. (canceled)

14. A method for repelling an arthropod pest, the method comprising applying a repellent composition of claim 1 to a surface.

15. The method of claim 14, wherein the arthropod pest is an insect pest.

16. (canceled)

17. The method of claim 14, wherein the composition comprises one or more of Sesamum indicum seed oil, ethyl alcohol and propyl alcohol.

18. The method of claim 14, wherein the fixative is vanillin.

19. The composition of claim 1, wherein the arthropod repellent is selected from the repellents listed in Table 1.

20. The method of claim 14, wherein the arthropod repellent is methyl N,N-dimethylanthranilate.

21. The method of claim 14, wherein the film-forming agent is capryloyl glycerin/sebacic acid copolymer.

22. The method of claim 14, used to inhibit, prevent and/or reduce the spread or incidence of pest-borne disease in plants, animals and/or humans.

23. (canceled)

24. The method of claim 14, wherein the surface is skin, fur, or clothing.
